(19) United States
(12) Patent Application Publication
(10) Pub. No.: US 2015/0051349 A1
(43) Pub. Date: Feb. 19, 2015

(54) POLYCARBONATE BLEND ARTICLES AND METHOD OF PRODUCING THE SAME

(71) Applicant: Rohm & Haas Company, Philadelphia, PA (US)

(72) Inventors: Veera G. Nelliappan, North Wales, PA (US); Eric G. Lundquist, North Wales, PA (US); Yannick Saint-Gerard, Roqueford-les-Pins (FR)

(21) Appl. No.: 14/387,884

(22) PCT Filed: Mar. 5, 2013
(86) PCT No.: PCT/US2013/028964

§ 371 Date: Sep. 25, 2014

Related U.S. Application Data
(60) Provisional application No. 61/622,373, filed on Apr. 10, 2012.

(51) Int. Cl. C08L 33/12; C08J 3/00; B29C 47/00; B29C 43/22; B29C 43/24; C08L 69/00; B29C 45/00

(52) U.S. Cl. CPC C08L 33/12; C08L 69/00; C08J 3/005; B29C 45/0001; B29C 43/22; B29C 43/24; B29C 47/0004; C08L 2201/02; C08L 2201/10; C08J 2369/00; C08J 2333/12; C08J 2469/00; C08J 2433/12; B29K 2033/12
USPC 525/185; 264/328.1; 264/319

(57) ABSTRACT

A scratch resistant article comprising a blend which comprises from 50 to 95 percent by weight polycarbonate; and from 5 to 50 percent by weight modified methyl methacrylate polymer, wherein the modified methyl methacrylate polymer is selected from the group consisting of modified methyl methacrylate homopolymer, modified methyl methacrylate copolymers, and combinations thereof; wherein the modified methyl methacrylate polymer has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols, wherein the modified methyl methacrylate polymer has a Mw from 5,000 to 100,000 g/mole; and wherein the blend exhibits a pencil hardness equal to or greater than F measured according to ASTM D3363-05 is provided. A method for making a scratch resistant article is also provided.

### FIELD OF INVENTION

The instant invention relates to a scratch resistant articles made from polycarbonate blends and method of making the same.

### BACKGROUND OF THE INVENTION

Generally, polycarbonate (PC) compositions exhibit properties such as high impact strength, flame retardancy and good transparency and for these reasons are the engineering resin of choice in electronic, appliance and automotive applications. Unfortunately, polycarbonate compositions have poor scratch resistance. One method of dealing with poor scratch resistance entails an expensive hard coating step in which a protective coating is applied to the surface of a PC article. Thus, a less expensive additive which could be blended with PC to produce a scratch resistant PC would be of commercial value.

Blends of polycarbonates and polymethyl methacrylate (co)polymers are known and have been investigated as a method of improving the scratch resistance of PC. Unfortunately, blends of PC and typical polymethyl methacrylates (PMMAs) are frequently opaque which is not acceptable for semi-transparent or transparent applications, and they often suffer from poor mechanical properties.

Moreover, PC and PMMA are immiscible in most proportions, and blends thereof are opaque over wide composition ranges and do not possess the advantageous properties exhibited by either polymer.

Techniques of overcoming the drawbacks associated with the immiscibility of typical PC/PMMA blends have been previously proposed. Among such techniques is the addition of copolymer additives, such as PMMA/acrylamide copolymers and PMMA-ester copolymers containing carbocyclic groups and the use of a block copolymer of PC and PMMA instead of a physical mixture of the two components.

A need exists for a modified PC composition, having an increase of three to four levels of hardness on the pencil hardness scale over the unmodified PC composition, that eliminates the need for a hard coating step and articles and methods of making such articles comprising such blends.

### SUMMARY OF THE INVENTION

The instant invention provides a scratch resistant polycarbonate article and methods of making the same.

In one embodiment, the instant invention provides a scratch resistant article comprising a blend which comprises from 50 to 95 percent by weight polycarbonate; and from 5 to 50 percent by weight modified methyl methacrylate polymer, wherein the modified methyl methacrylate polymer is selected from the group consisting of methyl methacrylate homopolymer, methyl methacrylate copolymers and combinations thereof; wherein the modified polymer has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols; and wherein the modified methyl methacrylate polymer has a weight average molecular weight, Mw, from 5,000 to 100,000 g/mole; and wherein the blend exhibits a pencil hardness equal to or greater than F measured according to ASTM D3363-05.

In an alternative embodiment, the instant invention further provides a method for making a scratch resistant article comprising: forming a blend by melt blending, the blend comprising from 50 to 95 weight percent polycarbonate and from 5 to 50 weight percent modified methyl methacrylate polymer; wherein the modified methyl methacrylatemethyl methacrylate polymer has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols; and wherein the modified methyl methacrylate polymer has an Mw equal from 5,000 to 100,000 g/mole and wherein the blend exhibits a pencil hardness equal to or greater than F measured according to ASTM D3363-05; and forming the scratch resistant article from the blend by one or more methods selected from the group consisting of extrusion molding, press molding, and calendaring.

### DETAILED DESCRIPTION OF EMBODIMENTS OF THE INVENTION

The following abbreviations are used herein:

“PMMA” means polymethmethacrylate;

“PC” means polycarbonate;

“BMP” means butyl mercapto propionate;

“MMA” means methyl methacrylate;

“(meth)acrylate” means acrylate or methacrylate;

“CHMA” means cyclohexmethyl methacrylate;

“nDDM” means normal dodecylmercaptan;

The instant invention provides a scratch resistant polycarbonate article and method of making the same.

The scratch resistant article according to the present invention comprises a blend which comprises from 50 to 95 percent by weight polycarbonate; and from 5 to 50 percent by weight modified methyl methacrylatemethyl methacrylate polymer, wherein the modified methyl methacrylatemethyl methacrylate polymer is selected from the group consisting of methyl methacrylatemethyl methacrylate homopolymer, methyl methacrylatemethyl methacrylate copolymers and combinations thereof; wherein the modified methyl methacrylatemethyl methacrylate polymer has one or more end groups provided by reaction with one or more chain transfer agents selected from the group consisting of of mercapto esters, cycloalkyl and substituted cycloalkyl thiols, hydroxyl thiols, aryl and substituted aryl thiols, and aminoalkyl thiols; wherein the modified methyl methacrylatemethyl methacrylate polymer has a Mw from 5,000 to 100,000 g/mole; and wherein the blend exhibits a pencil hardness equal to or greater than F measured according to ASTM D3363-05.

In an alternative embodiment, the instant invention further provides a method for making a scratch resistant article comprising forming a blend by melt blending, the blend comprising from 50 to 95 weight percent polycarbonate and from 5 to 50 weight percent modified methyl methacrylatemethyl methacrylate polymer; wherein the modified methyl methacrylatemethyl methacrylate polymer has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols; and wherein the modified methyl methacrylate polymer has an Mw equal from 5,000 to 100,000 g/mole and wherein the blend exhibits a pencil hardness equal to or greater than F measured according to ASTM D3363-05; and forming the scratch resistant article from the blend by one or more methods selected from the group consisting of extrusion molding, press molding, and calendaring.

All individual values and subranges from 50 to 95 percent by weight polycarbonate are included herein and disclosed herein; for example, the amount of PC in the blend can be from a lower limit of 50, 60, 70, 80 or 90 percent by weight to an upper limit of 55, 65, 75, 85 or 95 weight percent. For example, the amount of PC in the blend may be in the range of from 50 to 95 weight percent, or in the alternative, the amount of PC in the blend may be in the range of from 55 to 85 weight percent, or in the alternative, the amount of PC in the blend may be in the range of from 75 to 95 weight percent.

All individual values and subranges from 5 to 50 percent by weight modified methacrylatemethyl methacrylate polymer are included herein and disclosed herein; for example, the amount of modified methyl methacrylate can be from a lower limit of 5, 15, 25, 35 or 45 weight percent to an upper limit of 10, 20, 30, 40 or 50 weight percent. For example, the amount of modified methyl methacrylate polymer in the blend may be in the range of from 5 to 50 weight percent, or in the alternative, the amount of modified methyl methacrylate polymer may be in the range of from 15 to 45 weight percent, or in the alternative, the amount of modified methyl methacrylate polymer may be in the range of from 5 to 25 weight percent.

The modified methyl methacrylate polymer useful in embodiments of the inventive blend is selected from the group consisting of modified methyl methacrylatehomopolymer, modified methyl methacrylate copolymers and combinations thereof.

The term “modified” as used herein means that the methyl methacrylatemethyl polymer (modified methyl methacrylate homopolymer, modified methyl methacrylate copolymers or combinations thereof) has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols. Chain transfer agents utilized in the present invention are added to the free radical polymerization process. The use and mechanism of chain transfer agents is well known to those skilled in the art with the majority of the chain transfer agent ending up at the end of the polymer chain. By careful selection of chain transfer agent used in the polymerization of the (meth)acrylate monomers, the interaction of the poly methyl methacrylate with the polycarbonate may be influenced, giving a blend which has good scratch resistance, clarity and impact performance.

Mercapto esters, as the term is used herein, include those compounds having a moiety HS—X—C(═O)O—R or HS—X—OC(═O)R wherein X is a substituted or unsubstituted hydrocarbyl group having a valency of at least two, and R is an alkyl or aryl moeity. In embodiments of the inventive blend and/or method, one or more suitable mercapto esters may be used. In yet alternative embodiments of the inventive blend and/or method, no mercapto esters are used.

Exemplary mercapto esters include, but are not limited to, butylmercaptopropionate, methylmercaptopropionate, 2-ethylhexylthioglycolate, methylthioglycolate, ethylthioglycolate, mercaptoethyloleate, and mercaptoethyltallate,

Exemplary cycloalkyl thiols and substituted cycloalkyl thiols include, but are not limited to, furfuryl mercaptan, cyclohexane thiol, and 2-furanmethane thiol.

Exemplary aryl and substituted aryl thiols include, but are not limited to, benzene thiol, benzyl mercaptan, 2 or 4 bromobenzyl mercaptan, 2,4,6-trimethyl benzyl mercaptan, 2 or 4-aminothiophenol, and thiophenol

Exemplary hydroxyl alkyl thiols include, but are not limited to, 6-mercapto-1-hexanol, 4-mercapto-1-butanol, 8-mercapto-1-octanol. 1-thioglycerol, mercaptoethanol

Exemplary amine thiols include, but are not limited to, 4-acetamidothiophenol, amionoethanethiol.

In an alternative embodiment, the instant invention provides a scratch resistant article and method of making the same, in accordance with any of the preceding embodiments, except that the polycarbonate is a Bisphenol A− type and/or commercial type polycarbonate having a weight average molecular weight (Mw) from 10,000 to 250,000 g/mole. All subranges and values from 10,000 to 250,000 g/mole are included herein and disclosed herein. For example, the polycarbonate may have a Mw from 10,000 to 250,000 g/mole, or in the alternative, the polycarbonate may have a Mw from 20,000 to 100,000 g/mole, or in the alternative, the polycarbonate may have a Mw from 30,000 to 90,000 g/mole, or in the alternative, the polycarbonate may have a Mw from 50,000 to 100,000 g/mole.

In an alternative embodiment, the instant invention provides a scratch resistant article and method of making the same, in accordance with any of the preceding embodiments, except that the chain transfer agent is selected from the group consisting of butylmercaptopropionate, methylmercaptopropionate, benzyl mercaptan, furfuryl mercaptan, 1-phenylethyl mercaptan, mercaptan, 2-ethylhexyl thioglycolate, and mercaptoethanol.

Modified methyl methacrylate copolymers useful in embodiments of the inventive blend include copolymers of methyl methacrylate and one or more comonomers selected from the group consisting of (cyclo)alkyl (meth)acrylates, alkyl (meth)acrylates, aryl (meth)acrylates, styrene, and substituted styrene based monomers. In particular embodiments of the inventive blend, the methyl methacrylate copolymer comprises units derived from one or more comonomers selected from the group consisting of cyclohexyl methacrylate, isobornyl methacrylate, tetrahydrofurfuryl methacrylate, cyclopentyl methacrylate, trifluoroethylmethacrylate, hydroxyethylmethacrylate and dicyclopentadienyl methacrylate.

The methyl methacrylate copolymer useful in certain embodiments of the inventive blend comprises equal to or greater than 70 percent by weight derived from methyl methacrylate units and from greater than one and equal to or less than 30 percent by weight derived from of one or more comonomers. All individual values and subranges from at least 70 percent by weight derived from methyl methacrylate units are included herein and disclosed herein; for example, the amount derived from methyl methacrylate units can be from a lower limit of 70, 75, 80, 85, 90, 95 or 98weight percent. All individual values and subranges from greater than one to less than 30 percent by weight derived from one or more comonomer units are included herein and disclosed herein; for example, the amount derived from comonomer units can be from a lower limit of 1.5, 5, 10, 20, or 25 weight percent to an upper limit of 2, 7.5, 15, 25 or 29 weight percent.

In an alternative embodiment, the instant invention provides a scratch resistant article and method of making the same, in accordance with any of the preceding embodiments, except that the modified methyl methacrylate polymer has a Mw from 5,000 to 100,000 g/mole. All individual values and subranges from 5,000 to 100,000 g/mole are included herein and disclosed herein; for example, the Mw can be from a lower limit of 5,000; 25,000; 35,000; 45,000; 55,000; 65,000; 75,000; 85,000; or 95,000 g/mole to an upper limit of 10,000; 20,000; 30,000; 40,000; 50,000; 60,000; 70,000; 80,000; 90,000 or 100,0000 g/mole. For example, the Mw may be in the range of from 5,000 to 100,000 g/mole, or in the alternative, the Mw may be in the range of from 25,000 to 75,000 g/mole, or in the alternative, the Mw may be in the range of from 55,000 to 95,000 g/mole.

In an alternative embodiment, the instant invention provides a scratch resistant article and method of making the same, in accordance with any of the preceding embodiments, except that the inventive blend exhibits a pencil hardness equal to or greater than F measured according to ASTM D3363-05. All individual values and subranges from equal to or greater than F are included herein and disclosed herein; for example, the blend pencil hardness can be equal to or greater than F, or in the alternative, the blend pencil hardness can be equal to or greater than H.

In an alternative embodiment, the instant invention provides a scratch resistant article and method of making the same, in accordance with any of the preceding embodiments, except that a test sample made from the blend and measured according to ASTM D1003-11 has a haze of equal to or less than 50%. All individual values and subranges from equal to or less than 50% are included herein and disclosed herein; for example, the haze can be from an upper limit of 5%, 10%, 20%, 30%, 40% or 50%.

In an alternative embodiment, the instant invention provides a blend, and method of producing the same, in accordance with any of the preceding embodiments, except that the modified methyl methacrylate polymer is formed from the reaction of from 0.2 to10 weight percent chain transfer agent based on the total weight of the methyl methacrylate polymer. All individual values and subranges from 0.2 to 10 weight percent are included herein and disclosed herein; for example, the amount of chain transfer agent used to form the modified methyl methacrylate polymer can be from a lower limit of 0.2, 0.5, 1, 2, 4, 6, 8, or 9 weight percent to an upper limit of 1, 3, 5, 7, 9, or 10 weight percent. For example, the amount of chain transfer agent used to form the modified methyl methacrylate polymer may be in the range of from 0.5 to 10 weight percent, or in the alternative, the amount of chain transfer agent used to form the modified methyl methacrylate polymer may be in the range of from 2 to 10 weight percent, or in the alternative, the amount of chain transfer agent used to form the modified methyl methacrylate polymer may be in the range of from 5 to 10 weight percent, or in the alternative, the amount of chain transfer agent used to form the modified methyl methacrylate polymer may be in the range of from 1 to 5 weight percent,

In an alternative embodiment, the instant invention provides a scratch resistant article and method of making the same, in accordance with any of the preceding embodiments, except that the modified methyl methacrylate polymer has an index of refraction of less than 1.52, alternatively less than 1.51, alternatively less than 1.50.

In an alternative embodiment, the instant invention provides a scratch resistant article and method of making the same, in accordance with any of the preceding embodiments, except that the modified methyl methacrylate is prepared by one or more standard free radical polymerization techniques selected from the group consisting of emulsion polymerization, suspension polymerization, dispersion polymerization, bulk polymerization, and solution polymerization. In one embodiment, the modified methyl methacrylate polymer is prepared by solution polymerization.

In an alternative embodiment, the instant invention provides a scratch resistant article and method of making the same, in accordance with any of the preceding embodiments, except that the blend has a pencil hardness of equal to or greater than F measured according to ASTM D3363-05.

In an alternative embodiment, the instant invention provides a scratch resistant article, and method of making the same, in accordance with any of the preceding embodiments, except that the modified methyl methacrylate copolymer comprises equal to or greater than 70 percent by weight methyl methacrylate units and between greater than one and equal to or less than 30 percent by weight of one or more monomers selected from the group consisting of, alkyl (meth)acrylates, aryl (meth)acrylates, styrene, substituted styrene based monomers.

In an alternative embodiment, the instant invention provides a scratch resistant article and method of making the same, in accordance with any of the preceding embodiments, except that the article is selected from the group consisting of lenses, films, sheets, face shields, windows, dust covers, wind screens, screens, structural components, electronic components, construction materials, medical devices, data storage devices, automotive components, aircraft components, marine components, lighting components, storage components, communication equipment, solar energy components, photography equipment, video equipment, holographic materials, optical devices, and small appliance components.

In an alternative embodiment, the instant invention provides a scratch resistant article and method of making the same, in accordance with any of the preceding embodiments, except that the article is produced by one or more methods selected from the group consisting of calendaring, extrusion, compression molding and injection molding.

In an alternative embodiment, the instant invention provides a scratch resistant article and method of making the same, in accordance with any of the preceding embodiments, except that the article is produced by one or more methods selected from the group consisting of extrusion, lamination, co-extrusion, cast extrusion, and blow molding.

The ingredients of the polymer blends can be mixed or blended using methods known to a person of ordinary skill in the art, preferably methods that can provide a substantially homogeneous distribution of the modified methyl methacrylate in the polycarbonate. Non-limiting examples of suitable blending methods include melt blending and melt kneading, for example, in an extruder, and the like.

The articles may be made using any one or more of the methods discussed herein in a continuous or a discrete manner following the blending. Such methods to form an article comprising the blend include any appropriate method known to one of ordinary skill in the art, including, for example, calendaring, extrusion, compression molding, injection molding, co-extrusion, cast extrusion, and blow molding. For example, multi-layered sheets in which one or more of the layers comprises a blend of modified methyl methacrylate and polycarbonate may be made by first forming the blend by melt kneading in an extruder followed by co-extrusion with or onto another layer of appropriate material. Alternatively, the blend may be produced by melt blending and/or melt kneading with the formation of the article being accomplished in a separate process.

In an alternative embodiment, the instant invention provides a scratch resistant article and method of making the same, in accordance with any of the preceding embodiments, except that the blend further comprises one or more components selected from the group consisting of flame retardants, pigments, primary antioxidants, secondary antioxidants, processing aids, impact modifiers, UV stabilizers, plasticizers, blends thereof, and combinations thereof.

In an alternative embodiment, the scratch resistant article comprises a blend which consists essentially of from 50 to 95 percent by weight polycarbonate; and from 5 to 50 percent by weight modified methyl methacrylate polymer, wherein the modified methyl methacrylate polymer is selected from the group consisting of methyl methacrylate homopolymer, methyl methacrylate copolymers and combinations thereof; wherein the modified methyl methacrylate polymer has one or more end groups of mercapto esters, cycloalkyl and substituted cycloalkyl thiols, hydroxyl thiols, aryl and substituted aryl thiols, and aminoalkyl thiols wherein the modified methyl methacrylate polymer has a Mw from 5,000 to 100,000 g/mole; and wherein the blend exhibits a pencil hardness equal to or greater than F measured according to ASTM D3363-05.

In yet another alternative embodiment, the instant invention further provides a method for making a scratch resistant article consisting essentially of: forming a blend by melt blending, the blend comprising from 50 to 95 weight percent polycarbonate and from 5 to 50 weight percent modified methyl methacrylate polymer; wherein the modified methyl methacrylate polymer has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols and wherein the modified methyl methacrylate polymer has a Mw from 5,000 to 100,000 g/mole; and wherein the blend exhibits a pencil hardness equal to or greater than F measured according to ASTM D3363-05; and forming the scratch resistant article from the blend by one or more methods selected from the group consisting of extrusion molding, press molding, and calendaring.

In an alternative embodiment, the instant invention provides a scratch resistant article and method of making the same, in accordance with any of the preceding embodiments, except that the blend is thermodynamically miscible at most composition ranges. As used herein, the term “thermodynamically miscible” refers to a polymer blend that is mixed on the molecular level forming a single, homogeneous phase which exhibits only one glass transition.

In an alternative embodiment, the instant invention provides a scratch resistant article and method of making the same in accordance with any of the preceding embodiments, except that the blend exhibits more than one glass transition.

In an alternative embodiment, the instant invention provides a scratch resistant article, and method of making the same, in accordance with any of the preceding embodiments, except that the blend does not comprise any units derived from a crosslinker. Such crosslinkers which are not present in particular embodiments of the blend or used in embodiments of the method, include, for example, divinylbenzene; vinyl group-containing monomers including; allyl compounds including allyl (meth)acrylate, diallyl fumarate, diallyl phthalate, diallylacrylamide, triallyl (iso)cyanurate, and triallyl trimelitate; (poly)alkylene glycol di(meth)acrylate compounds including ethylene glycol dimethacrylate (EGDMA), diethylene glycol dimethacrylate, 1,6-hexanediol di(meth)acrylate, (poly)ethylene glycol di(meth)acrylate, (poly)propylene glycol di(meth)acrylate, (poly)tetramethylene glycol di(meth)acrylate, pentaerythritol tetra(meth)acrylate, pentaerythritol tri(meth)acrylate, pentaerythritol di(meth)acrylate, trimethylolpropane tri(meth)acrylate, dipentaerythritol hexa(meth)acrylate, dipentaerythritol penta(meth)acrylate, and glycerol tri(meth)acrylate and mixtures and combination thereof.

### EXAMPLE

The following example illustrates the present invention but is not intended to limit the scope of the invention.

### Example 1

### Preparation of Copolymer of Methyl Methacrylate and Cyclohexyl Methacrylate Polymer (Mod. MMA 1) Using a Solution Polymerization Process

1000 g of methyl ethyl ketone (MEK) was charged to a 5 liter round bottom flask fitted with inlet ports and a condenser. The contents were heated to 75° C. while being agitated with a paddle type agitator at a rate of 90 rpm and gently swept with nitrogen. After 30 minutes of sweep 0.94 g of TRIGONOX 125-C75 was charged (tent-butyl peroxy pivalate, available from AkzoNobel Company) to the kettle; subsequently 752 g of methyl methacrylate, 189 g of cyclohexyl methacrylate, 9.6 g of Trigonox 150-C75 (in 47 g of MEK) and 28 g of butyl mercaptopropionate were fed as three different streams over 3 hours, while maintaining the temperature at 75° C.

After completion of the feeds, the contents of the reaction flask were heated to 80° C. and held at that temperature for 2 hrs. The typical conversion at this point is >98%. Subsequently, 4.3 g of TRIGONOX 150-C75 was added over a period of 2 hrs while the reaction flask was maintained at 80° C. Then the contents of the reaction flask were cooled to 50° C., poured into trays and dried to a solvent content of <5000 ppm. The resulting polymer mass was ground with a mortar and pestle and further dried to a solvent content less than <1000 ppm in a vacuum oven (<18″ Hg and 75° C.). The isolated polymethyl methacrylate was compounded with LEXAN 141R in a counter rotating LEISTRITZ twin screw extruder operating at 100 rpm. The barrel temperature ranged from 248° C., to 265° C. at the die. The resulting strands were pelletized and dried overnight in a vacuum oven at 60° C. 1.5 mm plaques were pressed out of the compounded blend of LEXAN 141R polycarbonate and the Inventive Example 1 at a temperature of 170° C., and 5000 psi pressure. The plaques were held at that temperature and pressure for 2 minutes and demolded using a CARVER laboratory press. A plaque of LEXAN 141R was prepared using similar conditions. A laminate of 3 mm thickness was prepared by sandwiching the LEXAN 141R polycarbonate plaque and the plaque prepared from the blend, also using similar conditions. Haze, pencil scratch and impact were measured on the resulting specimen.

TABLE 1
The composition, molecular weight and the calculated refractive
index of the different acrylic modifiers and Lexan ™
polycarbonate is listed in the Table below

| EXAMPLE | Composition wt % | Mw | RI |
|---|---|---|---|
| LEXAN 141R Polycarbonate | polycarbonate | 49,000 | 1.58 |
| without additives (control) | | | |
| Mod. MMA 1 | 98% MMA/3% BMP | 9,300 | 1.49 |

TABLE 2
Illustrates the haze and pencil hardness and impact energy
of the laminates prepared with LEXAN 141R polycarbonate
and a 70/30 blend of LEXAN 141R: Mod. MMA1.

| Composition of each layer | | | | Total impact |
|---|---|---|---|---|
| of the laminate | | | Pencil | (energy to |
| Layer 1 | Layer 2 | Haze % | hardness | break. ft lbf) |
| LEXAN141 R | Lexan 141R | 1.7 | H | 4.0 |
| Polycarbonate | 70 wt % and | | | |
| (layer 1) - 100% | Mod. MMA 1 | | | |
| | 30 wt % | | | |

### Test Methods

### Pencil Hardness

Hardness, as used herein, refers to hardness as determined according to ASTM D3363-05 “Standard Test Method for Film Hardness by Pencil Test.” This standard test would be followed except that the test would be conducted on an injection molded test specimen in the shape of a plaque with dimensions 3×50×50 mm. The pencil would be held at a 45° angle and drawn across the surface of the plaque away from the operator starting with the hardest pencil with a load of 750 g. The substrate hardness would be reported as the hardness of the hardest pencil that did not scratch the surface. The pencil hardness scale from softer to harder is 2B, B, HB, F, H, 2H, 3H, etc.

### GPC

The term “molecular weight” as used refers to peak average molecular weight as determined by gel permeation chromatography against narrow molecular weight polystyrene standards in tetrahydrofuran solvent at 25° C. using Polymer Laboratories' data manipulation software.

### DSC

The glass transition is measured in a TA INSTRUMENTS Q1000 Differential Scanning calorimeter using a small sample of the polymer (5-20 mg) sealed in a small aluminum pan. The pan is placed in the DSC apparatus, and its heat flow response is recorded by scanning at a rate of 10° C./min from room temperature up to 180° C. The glass transition temperature is observed as a distinct shift in the heat flow curve.

### Haze

ASTM Standard Test Method for Haze and Luminous Transmittance of Transparent Plastics, D1003-11 was used for measuring the haze values of different specimens.

### Impact Resistance

ASTM Standard Test Method for Impact Resistance of Flat Rigid Plastic Specimens by Means of a Falling Dart, D5628-10 was used to determine the impact resistance of the different specimens.

The present invention may be embodied in other forms without departing from the spirit and the essential attributes thereof, and, accordingly, reference should be made to the appended claims, rather than to the foregoing specification, as indicating the scope of the invention.

We claim:

1. A scratch resistant article comprising:
a blend which comprises
from 50 to 95 percent by weight polycarbonate; and
from 5 to 50 percent by weight modified methyl methacrylate polymer,
wherein the modified methyl methacrylate polymer is selected from the group consisting of the modified methyl methacrylate homopolymer, modified methyl methacrylate copolymers, and combinations thereof;
wherein the modified methyl methacrylate polymer has one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols
wherein the modified methyl methacrylate polymer has an Mw from 5,000 to 100,000 g/mole; and
wherein the blend exhibits a pencil hardness equal to or greater than F measured according to ASTM D3363-05.

2. The scratch resistant article according to claim 1, wherein the blend has a haze of equal to or less than 50%, measured according to ASTM D1003.

3. The scratch resistant article according to claim 1, wherein the modified methyl methacrylate polymer is a modified methyl methacrylate copolymer which comprises equal to or greater than 70 percent by weight units derived from methyl methacrylate and between greater than one and equal to or less than 30 percent by weight of units derived from one or more monomers selected from the group consisting of (cyclo)alkyl (meth)acrylates, alkyl (meth)acrylates, aryl (meth)acrylates, styrene, and substituted styrene based monomers.

4. The scratch resistant article according to claim 1, wherein the modified methyl methacrylate copolymer comprises equal to or greater than 70 percent by weight units derived from methyl methacrylate and between greater than one and equal to or less than 30 percent by weight units derived from of one or more monomer units selected from the group consisting of cyclohexyl methacrylate, isobornyl methacrylate, tetrahydrofurfuryl methacrylate, cyclopentyl methacrylate, hydroxy ethyl methacrylate, trifluoroethylmethacrylate, and dicyclopentadienyl methacrylate.

5. The scratch resistant article according to claim 1, wherein the modified methyl methacrylate polymer is formed from the reaction of from 0.5 to 10 weight percent chain transfer agent based on the total weight of the methyl methacrylate polymer.

6. The scratch resistant article according to claim 1, wherein the chain transfer agent is selected from the group consisting of butylmercaptopropionate, methylmercaptopropionate, benzyl mercaptan, furfuryl mercaptan, 1-phenylethyl mercaptan, cyclohexyl mercaptan, 2-ethylhexyl thioglycolate, and mercaptoethanol.

7. The scratch resistant article according to claim 1, wherein the modified methyl methacrylate is prepared by one or more free radical polymerization techniques selected from the group consisting of emulsion polymerization, suspension polymerization, dispersion polymerization, bulk polymerization, and solution polymerization.

8. The scratch resistant article according to claim 1, wherein the modified methyl methacrylate polymer is prepared by solution polymerization.

9. The scratch resistant article according to claim 1, wherein the modified methyl methacrylate polymer has a refractive index less than 1.52.

10. The scratch resistant article, according to claim 1, wherein the article is produced by one or more methods selected from the group consisting of calendaring, extrusion, compression molding and injection molding.

11. The scratch resistant article, according to claim 1, wherein the article is produced by one or more methods selected from the group consisting of extrusion, lamination, co-extrusion, cast extrusion, and blow molding.

12. A method for producing a scratch resistant article comprising:
forming a blend by melt blending, the blend comprising from 50 to 95 weight percent polycarbonate and from 5 to 50 weight percent modified methyl methacrylate polymer;
wherein the modified methyl methacrylate polymer is a modified methyl methacrylate homopolymer, modified methyl methacrylate copolymer or combination thereof, having one or more end groups provided by reaction with one or more chain transfer agents selected from the group consisting of mercapto esters, cycloalkyl and substituted cycloalkyl thiols, hydroxyl thiols, aryl and substituted aryl thiols, and aminoalkyl thiols and
wherein the modified methyl methacrylate polymer has a Mw equal from 5,000 to 100,000 g/mole;
wherein the blend exhibits a pencil hardness equal to or greater than F measured according to ASTM D3363-05; and
forming the scratch resistant article from the blend by one or more methods
selected from the group consisting of extrusion, injection molding, compression molding, and calendaring.

13. The method according to claim 12, wherein the blend has a haze of less than or equal to 50% measured according to ASTM D1003.

14. The method according to claim 12, wherein the blend has a pencil hardness of equal to or greater than F measured according to ASTM D3363-05.

15. The method according to claim 12, wherein the modified methyl methacrylate polymer is a modified methyl methacrylate copolymer which comprises equal to or greater than 70 percent by weight units derived from methyl methacrylate and between greater than one and equal to or less than 30 percent by weight units derived from one or more monomers selected from the group consisting of alkyl (meth)acrylates, aryl (meth)acrylates, styrene, and substituted styrene based monomers.
